(19) United States
(12) Patent Application Publication
(10) Pub. No.: US 2013/0262968 A1
(43) Pub. Date: Oct. 3, 2013

(54) APPARATUS AND METHOD FOR EFFICIENTLY REVIEWING PATENT DOCUMENTS

(71) Applicant: PATENT SPEED, INC., San Diego, CA (US)

(72) Inventors: John E Gartman, San Diego, CA (US); Thomas N Millikan, San Diego, CA (US); Joseph P Reid, San Diego, CA (US)

(73) Assignee: Patent Speed, Inc., San Diego, CA (US)

(21) Appl. No.: 13/854,020

(22) Filed: Mar. 29, 2013

Related U.S. Application Data
(60) Provisional application No. 61/618,734, filed on Mar. 31, 2012.

(51) Int. Cl. G06F 17/27

(52) U.S. Cl. CPC G06F 17/2705
USPC 715/202

(57) ABSTRACT

Apparatuses and methods are provided for efficiently and effectively reviewing patent documents that can include, e.g., issued patent documents, patent applications, patent file histories, and the like. Different aspects of/patent data associated with patent documents may be identified, parsed, and/or extracted from patent documents. These different aspects/patent data may be used to create an interactive patent document. Through a user interface, a user can interact with the interactive patent document to review, analyze, or otherwise peruse a patent document, e.g., determine claim dependencies, correlate figure elements to specification text, determine antecedent basis of claim terms, etc.

### TECHNICAL FIELD

Various embodiments of the present disclosure relate to systems and methods for using text and image rendering to more efficiently and comprehensively review patent documents.

### BACKGROUND

Reviewing patent documents is difficult, time consuming, and labor intensive. By definition, patents contain new and non-obvious content, which makes understanding them far more difficult than understanding other documents. While for a rare few, reading a patent document might resemble skimming through a novel or even intensely studying a college textbook that cogently presents historically known materials, for most the process of reviewing patent documents is a frustrating exercise in cross-referencing backward and forward, reading and re-reading, trying to remember the part of a figure that text, e.g., a section of a specification, is trying to explain, or trying to find it, and worse. While comical in today's electronic world, it is not at all uncommon to see engineers, experienced patent lawyers, judges, and even jurors printing and spreading all the pages and figures of patents on huge tables or stapling them to a large wall in an array so that all the material can be cross-referenced more easily and efficiently. This is neither a fun nor efficient exercise, and it frequently leads to mistakes.

Beyond sheer technical complexity of the subject matter of a patent, part of the problem is the inherent non-linearity of patent documents. While patent documents—applications, file histories, and patents themselves—are presented in linear fashion like other written materials, to truly understand them requires cross-referencing and integrating numerous, disparate portions of the patent documents despite their linear and distant presentation in their native form. For example, patent documents can include some combination of figures and text. Because both the figures and text describe the subject matter of a patent, numeric cross-references are made in the text to enumerated portions of the figures. The review is complicated further because the numbered portions of the figures are typically not themselves named on the figures. Thus, to truly understand a patent, a reviewer must review and understand both the figures and the text, and hunt back and forth between the text and the figures to find and cross-correlate material/content. Similarly, part of the text contains claim statements that set forth the claimed invention, while other portions of the text describe figures and details of the invention, i.e., the aforementioned specification. Accordingly, to truly understand the claimed invention, a reviewer must review the claims in light of the figures and other text.

Typically, patent documents are available to the public in one of several formats, all of which separate the figures from the text in some way. For example, the most traditional format for patent documents is a paper, or hard-copy, format. Paper patent documents contain a cover page, followed by pages of numbered drawings, followed by pages of text presented in numbered columns and lines. Another common format for patent documents is one of several electronic file types that are, themselves, simply images of the pages of a paper patent document. Examples of this would include the .PDF files available at Google Patents, or the .PDF, .JPG, .BMP, or .TIF formats that can be created by commercially-available electronic scanners. In these file types, pages of a patent document may be recorded as separate pages within a single file or separate files. Further still, through the search engine provided by the United States Patent & Trademark Office (USPTO) website, one can obtain electronic copies of patent documents that consist of the text in HTML, while the drawings are maintained as separate image files.

As one can imagine, because the text and figures of a patent document are separated in each of these formats, reviewers of such patent documents are forced to jockey back and forth between them. In the paper format, this may require constant flipping between pages. In electronic formats, it may mean having multiple files open on a device at any one time and switching between them.

Making matters even worse, other details about the patent documents—whether related patents or applications exist, to whom the patent has been assigned, the patent's expiration date, etc.—can require reference to still other materials outside the patent documents themselves, such as databases maintained by the USPTO.

Despite the disjointed nature of all of this information that can be contained or alluded to in a patent document, legal and technical professionals are often called upon to review patent documents. They are also often required to summarize such patent documents for others, including referencing external details and/or excerpting from the patent documents themselves to illustrate or explain certain points. Given the limitations of all of these systems, such tasks can be incredibly time consuming, inefficient, and rife with costly mistakes.

### SUMMARY

In accordance with various embodiments, apparatuses and methods are provided to simply and efficiently review patent documents by creating an interactive patent document that pulls together the necessary information from various sources and intelligently integrates it. Further, various embodiments improve the cross-referencing between text and figures, and between claims and other portions of a patent document. Additionally, still, various embodiments provide mechanisms to obtain information external to the patent documents, e.g., during their review, and to streamline processes for excerpting and/or presenting information from and/or about patent documents.

### BRIEF DESCRIPTION OF THE DRAWINGS

For a more complete understanding of various embodiments, reference is made to the following descriptions taken in conjunction with the accompanying drawings in which:

FIG. 1 shows an exemplary network in which remote computing devices connect to a source of information;

FIG. 2 shows a block-level server architecture;

FIG. 3 shows a block-level diagram of an application that will run on end devices;

FIG. 4 shows a comparison of traditional, printed pages of a patent and integrating text and figures;

FIG. 5 shows positional controls for a user interface;

FIG. 6 shows highlighting and annotation controls for a user interface;

FIG. 7 shows magnification controls for a user interface;

FIG. 8 shows figure highlighting and annotation controls for a user interface;

FIG. 9 shows using active linking to move from the text to a figure using a user interface;

FIG. 10 shows using active linking to move from a figure to the text using a user interface;

FIG. 11 shows hierarchizing claims using a user interface;

FIG. 12a shows navigating from claim language to specification text using a user interface;

FIG. 12b shows an alternate way of reviewing specification text related to a particular claim term using a user interface;

FIG. 13 shows a user interface for creating and tying together snippets of text;

FIG. 14 shows a user interface that identifies related patent documents;

FIG. 15 shows a user interface that displays miscellaneous information about a patent document;

FIG. 16 shows hardware associated with a computer workstation capable of converting raw patent data into an interactive patent document;

FIG. 17 shows the hardware associated with a tablet capable of running a user interface;

FIG. 18 shows a flowchart of the operation of the server architecture; and

FIG. 19 shows a flowchart of the operation of the print engine.

### DETAILED DESCRIPTION

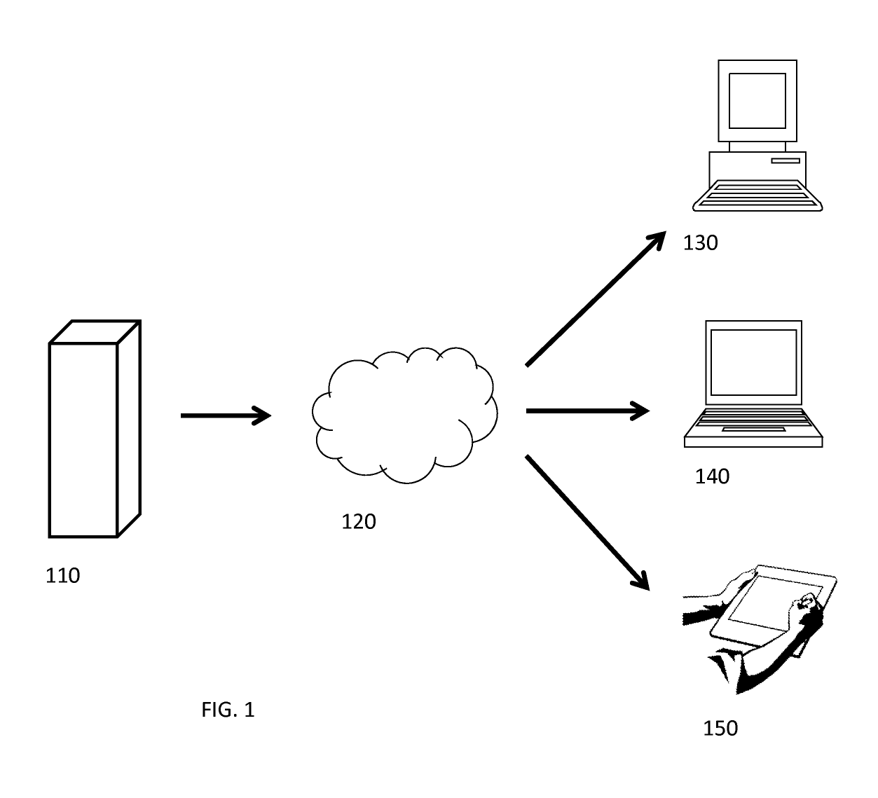

Multiple devices can access information stored on a server. Such devices may be connected to the server directly or, as is occurring with increasing frequency, they may indirectly access the server. Such an indirect arrangement is depicted in FIG. 1, where server 110 provides information through the cloud 120, such as the Internet, to end computing devices such as workstation 130, laptop 140, and tablet 150. Server 110 and cloud 120 can synchronize information between devices, including information added to a file by one user on a device, or a file downloaded onto one device. It should be noted that the arrangement in FIG. 1 is meant to be merely illustrative, as server 110 could be replaced with multiple, connected servers or other forms of bulk storage, the remote cloud connection could be replaced for any or all end devices by wired or other networked connections, and the end devices could be comprised of any variation or permutation of the depicted devices or other devices capable of networking and performing computing tasks, such as smart phones, Internet-capable game systems and televisions, and so forth.

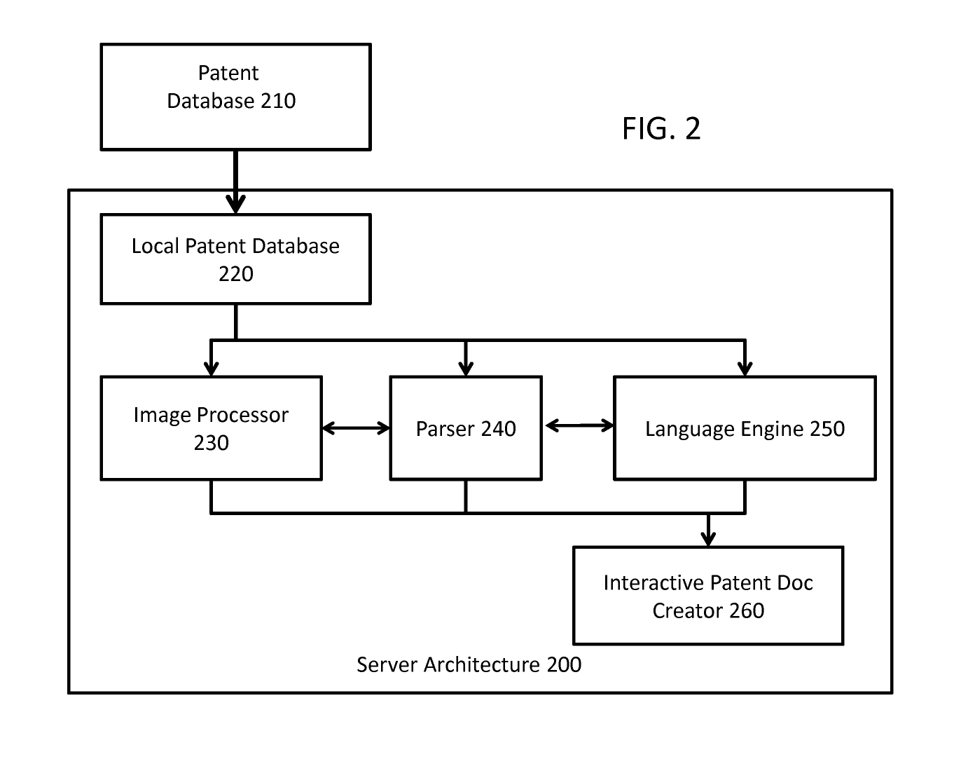

FIG. 2 depicts the server architecture 200 at a block diagram level for creating an interactive patent document. By way of the Internet or other form of data acquisition, server architecture 200 creates a local patent database 220 from the database maintained by the USPTO, i.e., patent database 210 or other sources maintaining patent data. Individual patent documents, including issued patents or applications, from within the local patent database 220 can then be provided to image processor 230, parser 240, and language engine 250. Image processor 230, parser 240, and language engine 250 can communicate and provide data to one another. Image processor 230, parser 240, and language engine 250 can provide data to interactive patent document creator 260.

Language engine 250 can use semantic, natural language processing, dictionaries, wordstem or other known techniques and data to assist parser 240 in finding patterns amongst and between the claims and specification. For example, language engine 250 can identify which words in a claim are meaningful, where a term starts and stops, whether terms have antecedent basis, and variants of a word (e.g., “interpolating” and “interpolate”)

Image processor 230 can perform optical character recognition (OCR) to identify letters and numbers in the patent data, including figures. Image processor 230 can extract figures from patent data, crop, rotate, and enhance the figures. Image processor 230 can also insert links between numeric labels on the figures and portions of the patent, including the specification, when provided by parser 240 and/or language engine 250. Image processor 230 can also overlay text identifiers found in the specification adjacent to the textual (e.g., numeric and/or text) labels in the figures. It should be noted that the term numeric as utilized herein can refer to a combination of numbers and text/letters. Figures, links, and labels can be provided to interactive patent document creator 260.

Parser 240 can parse the specification, based on text, XML, or OCR'd data found by image processor 230. Parser 240 can locate textual identifiers for each textual label in the figures. Parser 240 can identify and insert links between figures and the specification so that the numeric labels and/or identifiers jump to the portion of the specification that discusses them or selecting a numeric identifier pulls up the corresponding figure. Parser 240 can anchor the figures to the portion of the specification that identifies them so the specification and figures can be simultaneously displayed. A single figure can be anchored multiple times. Multiple figures can be anchored together where the specification discusses them in unison. Specification and anchor information can be provided to interactive patent document creator 260.

Parser 240 can correlate text to identifying markers, e.g., column and line numbers (or paragraph numbers in the case of, e.g., patent applications) by comparing OCR'd data of patent document images, which include or paragraph numbers, to patent text. The column and line or paragraph numbers can be provided to interactive patent document creator 260 as metadata. Parser 240 can also parse the claim language, including identifying which claims are dependent upon which other claims, which claims have common elements, and where claim terms are found in the specification. Parser 240 can analyze bibliographical information in the patent data, and access other databases to build family tree data. Parser 240 can also collect and process other metadata about the patent such as patent expiration, assignee chain, reexamination status, reissue status, and maintenance fee status. Parser 240 can also perform antecedent basis analysis of the claim language, and identify where no antecedent basis exists or multiple antecedent bases exist. Parser 240 can also identify where in claim elements, including claims from which a current claim depends, the antecedent basis is derived and mark the antecedent relationship using metadata. The column and line (or paragraph) numbers, dependent claim information, common claim element information, location of terms in the specification, bibliographical information, antecedent basis data, and other patent metadata can be provided to interactive patent document creator 260.

Interactive patent document creator 260 can take the information provided to it by image processor 230, parser 240, and language engine 250 to create a distributable document including images, cross links, hyperlinks, and other metadata in a standard format, such as ePub or using XML, or in a proprietary format. Server architecture 200 can also use Digital Rights Management (DRM) tools to secure the contents of the interactive patent file. Server architecture 200 can also store multiple interactive patent files. Server architecture 200 can pre-process patent data to create interactive patent files or wait for a request for a specific patent document before creating an interactive patent file.

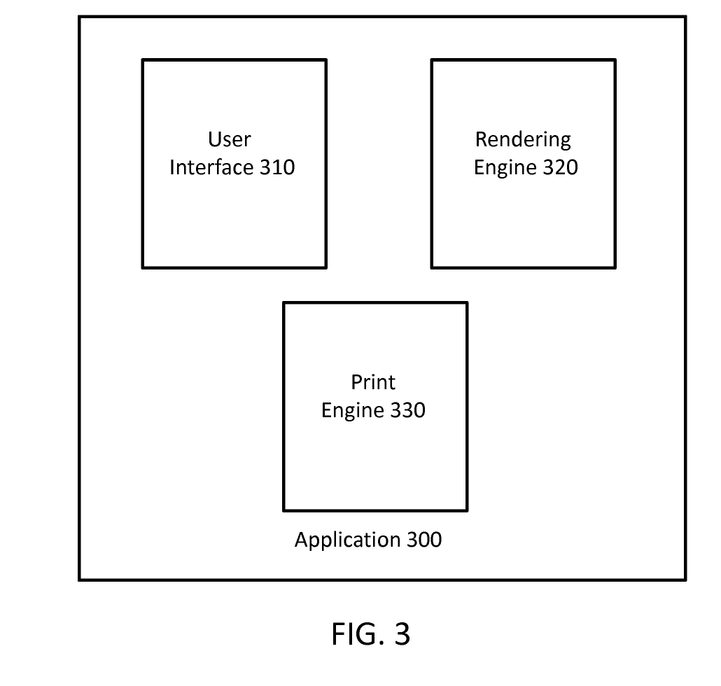

FIG. 3 depicts a block-level functionality of an application 300 running on one or more end devices, like the ones represented by workstation 130, laptop 140, and tablet 150 in FIG. 1, that interacts with an interactive patent document. While application 300 may include functionality described above in FIG. 2, application 300 contains three modules, a user interface 310, a rendering engine 320, and a print engine 330. As discussed in the following figures, application 300 presents an interactive patent document that allows for specification-based navigation (i.e. starting with the specification and displaying relevant information from the claims and figures in the context of the spec), figure-based navigation (i.e. starting with the figures and displaying relevant information from the specification and claims in the context of the figures) and/or claim-based navigation (i.e. starting with the claims and displaying relevant information from the specification and figures in the context of the claims). The various navigation modes can be selected by the user, either in an options menu, based on past practice, or by where the user jumps into the document to begin reviewing it. User interface 310, rendering engine 320, and print engine 330 are discussed in further detail in the following figures.

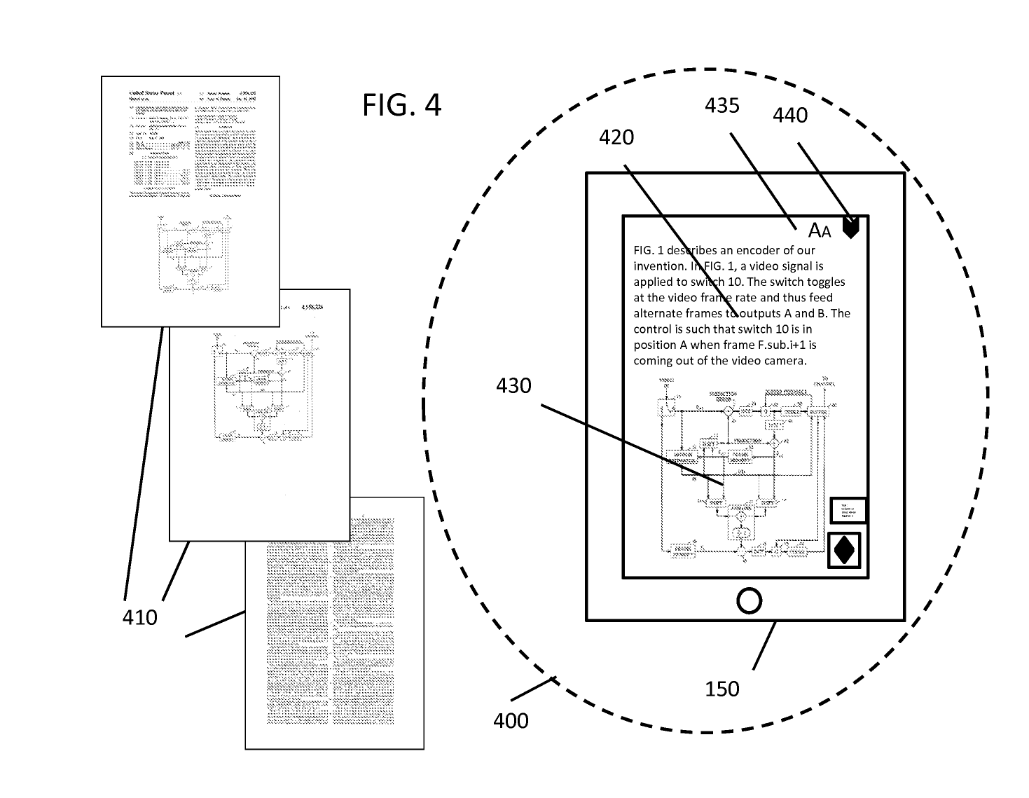

In FIG. 4, one can see one of the main problems with patents printed on paper, i.e., the text of the specification is separated from the figures, as shown by the three printed patent pages 410. In order to appreciate the text on one of the printed patent pages 410, a reviewer must flip to and also consider one or more figures on another printed patent page, the information on the patent's printed cover page, and so forth. In contrast, and in accordance with one embodiment, diagram 400 shows a user interface running on tablet 150. In this portion of the user interface, words from a passage of a particular patent specification are presented as rendered text 420, while the figure germane to that particular passage of rendered text is displayed simultaneously as an integrated image 430. The user interface can also adjust the text size using text size control 435. The user interface also permits a user to bookmark a passage or figure using book mark control 440. While the document being shown is an issued patent, this feature of the user interface would function identically when displaying other types of patent documents, such as patent applications or file histories.

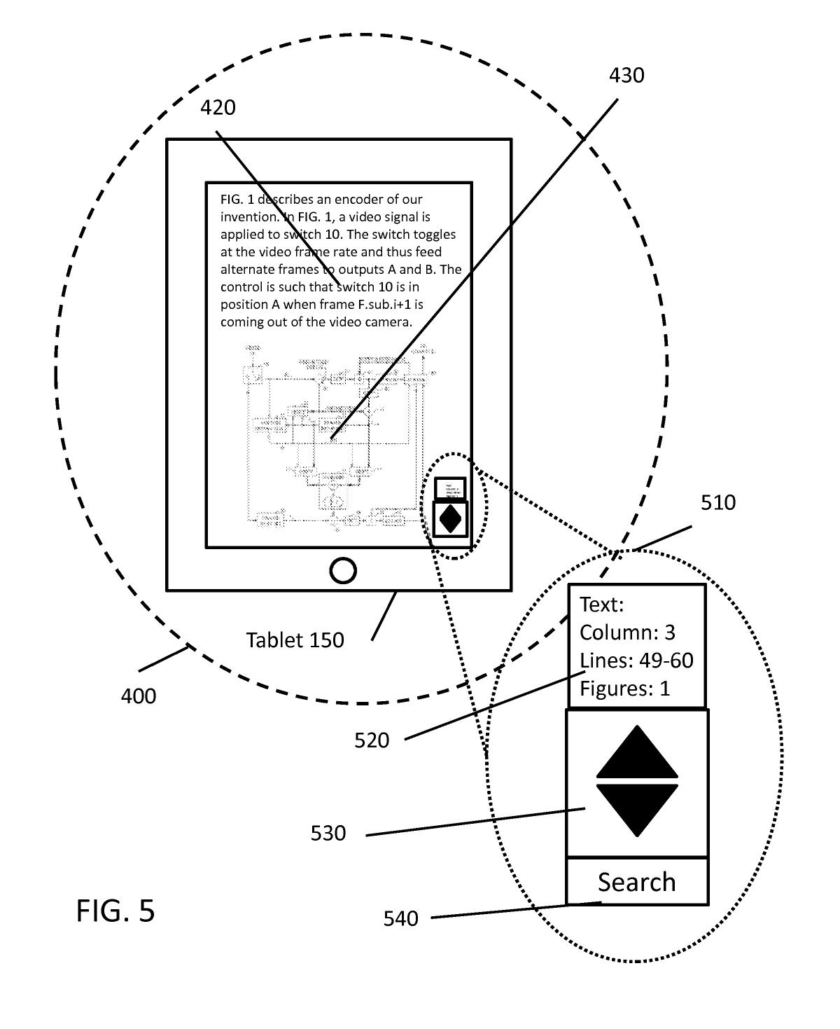

FIG. 5 provides additional detail regarding a user interface. Specifically, in FIG. 5 one example control 510 is shown. Control 510 contains a location indicator 520 that communicates where within the patent the current passage of text and figure being displayed are located, e.g., by their column and line numbers and figure numbers, respectively. Control 510 also contains a forward/back control 530 that allows the reviewer to move in either direction within the text of the patent document. Finally, control 510 includes text search control 540, by which a reviewer can search for, and locate, particular words within the patent document. One of skill in the art will recognize there are many other controls that could be used and control 510 is but one example.

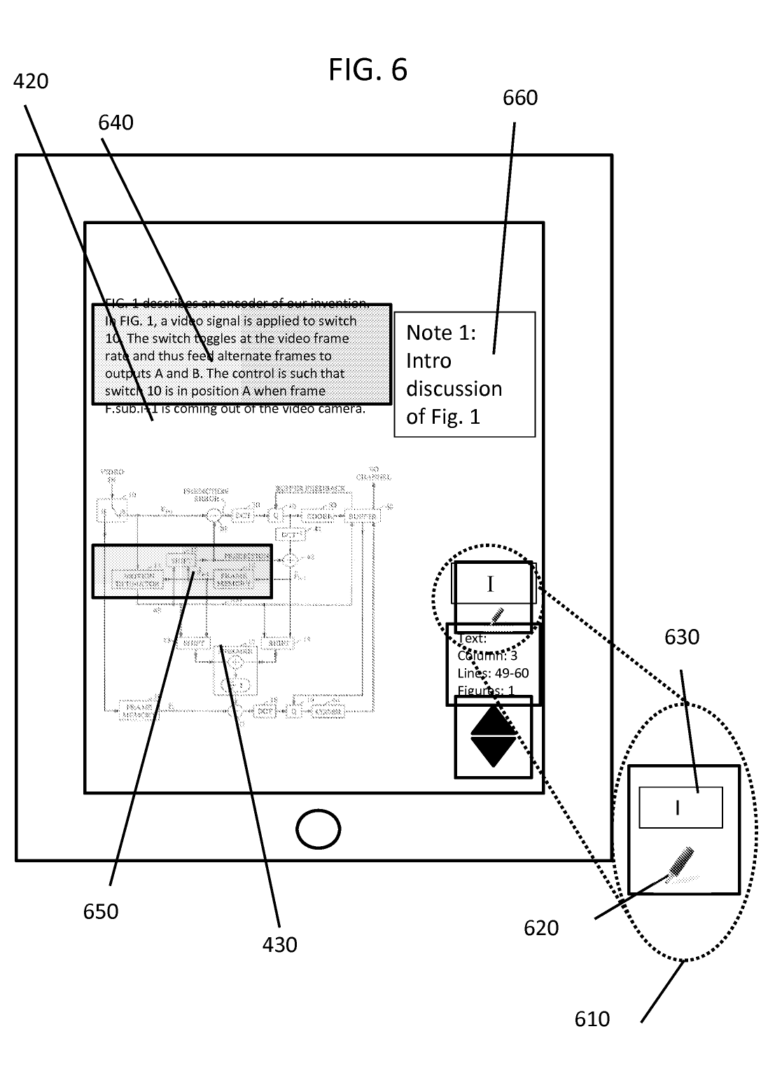

Quite often as reviewers study and analyze patent documents they wish to make notes and/or highlight material in the text, figures, or both. FIG. 6 depicts another aspect of a user interface that allows reviewers of patent documents to do each of those tasks. When viewing rendered text 420 and integrated image 430 on an end device, control 610 is provided to the reviewer. Control 610 includes a highlight control 620 that can be used to mark portions of text, such as text highlight 640, or portions of figures, such as figure highlight 650. While these highlighted portions are depicted in FIG. 6 as boxes, it should be understand that in operation, they may alternatively consist of color markings that imitate the use of a highlighter marker on a piece of paper, or other, similar visual cues that call attention to the portions being highlighted. Control 610 also includes a text control 630, with which a reviewer can add text notes of his own creation adjacent to portions of the text or figures, such as user annotation 660.

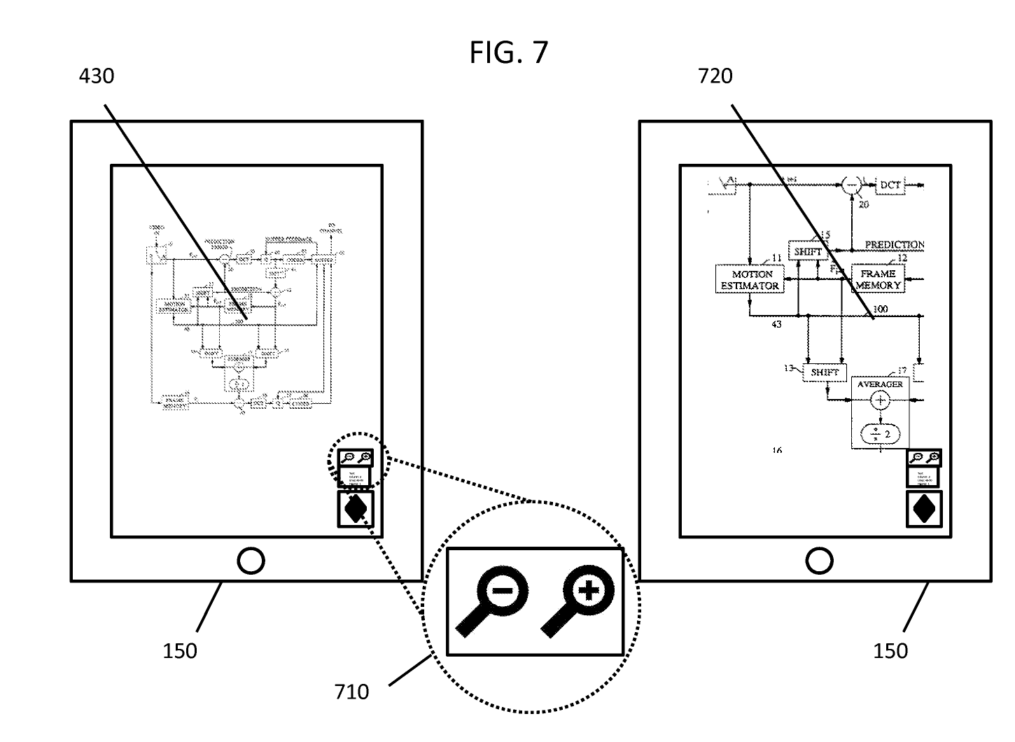

Figures and drawings in patent documents sometimes include small details that are difficult to read or fully appreciate with the unassisted eye. Similarly, many reviewers may have eyesight impairments that require them to review enlarged versions of text and/or figures. FIG. 7 shows an aspect designed to assist in both these scenarios. When a portion of rendered text or an integrated image is displayed on an end device, such as the tablet 150 depicted on the left-hand side of FIG. 7, a zoom control 710 is available to the reviewer. Using zoom control 710, a reviewer can magnify a portion of the text or figure in question, resulting in a larger, more easily readable version such as magnified image 720.

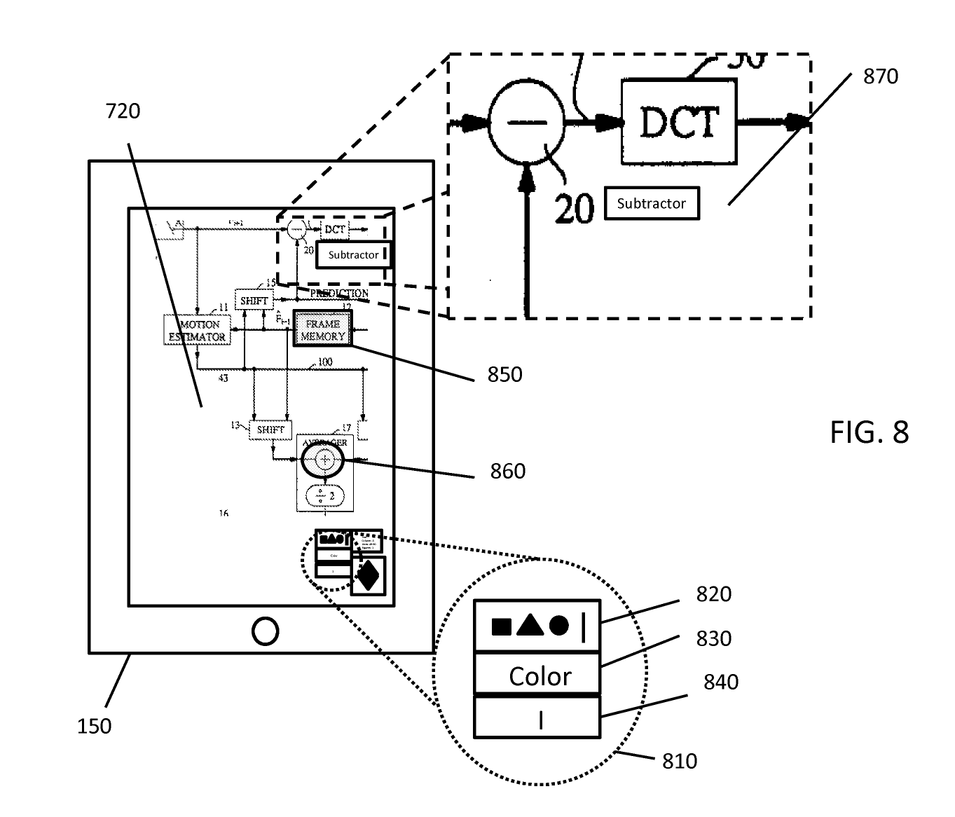

In addition to magnifying figures, when reviewing patent documents it may be helpful to be able to mark individual structures within a single figure. Accordingly, FIG. 8 depicts a user interface that allows such markings. Control 810 can include three components, a shape/line selector 820, a color selector 830, and a text control 840. Using shape/line selector 820 and color selector 830 in combination, a reviewer can create various shapes and lines of different colors to call attention to different aspects of the figure. The results of one example of such a review process are shown by first user-defined color shape 850 and second user-defined color shape 860, marking the rectangular “Frame Memory 12” and the circular adder portion of “Averager 17,” respectively.

Descriptor 870 has been pulled from the specification based on the numeric identifier “20” in the figure, and is automatically displayed adjacent to numeric identifier “20” in the figure. In situations where numeric identifiers in figures cannot be automatically annotated from the specification or additional annotation is desired, text control 840 allows a reviewer to add his own text to the figure, for example to add the name of a particular structure adjacent to its figure number similarly to that shown by descriptor 870. Further, automatically generated descriptors can be modified.

Descriptors can be automatically done in advance or on-the-fly for every number in the figures, or for selected individual numbers, or just for the first appearance of a number. Triggering mechanisms for creating the descriptors include menus (where one might, for example, click a radio button to add descriptors to each number in each figure), clicking on numbers to add a descriptor on the fly, or hovering a mouse pointer over a number and having a descriptor appear in a magnifying glass or other “travelling” type of view. Voice recognition may also be used as a triggering device.

These triggers may also be combined with other types of controls to allow the text surrounding the descriptor also to appear. This adaptation allows the end user to see the textual context in which the descriptor appears, perhaps helping the user better understand the descriptor.

As but one example, a figure might originally have no displayed descriptors, but mousing over (or, for a tablet, fingering over) any number would cause a descriptor to explode into view. Holding down the left mouse button while viewing the exploded descriptor would cause more and more text around the descriptor to appear. Releasing the left mouse button would stop the context expansion and give the user time to read and digest the material presented by the descriptor(s). Clicking the left mouse button again would cause the descriptor and all contextual material to disappear from view. This context-exploding technique can help the user understand the document more quickly.

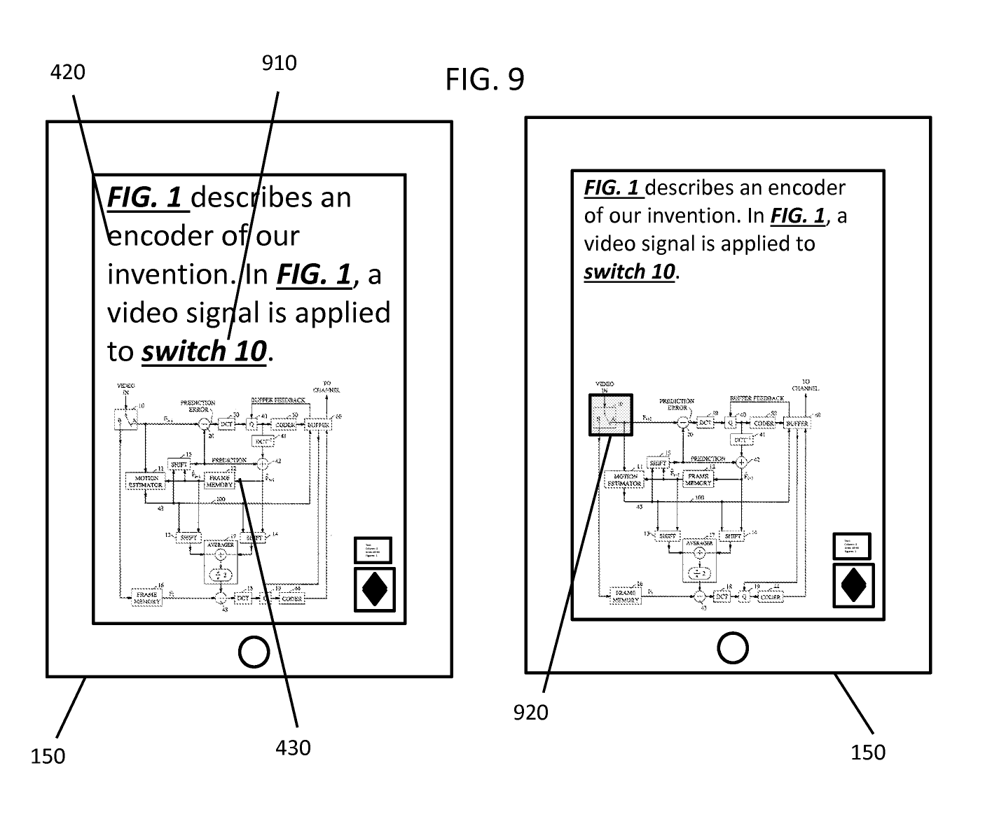

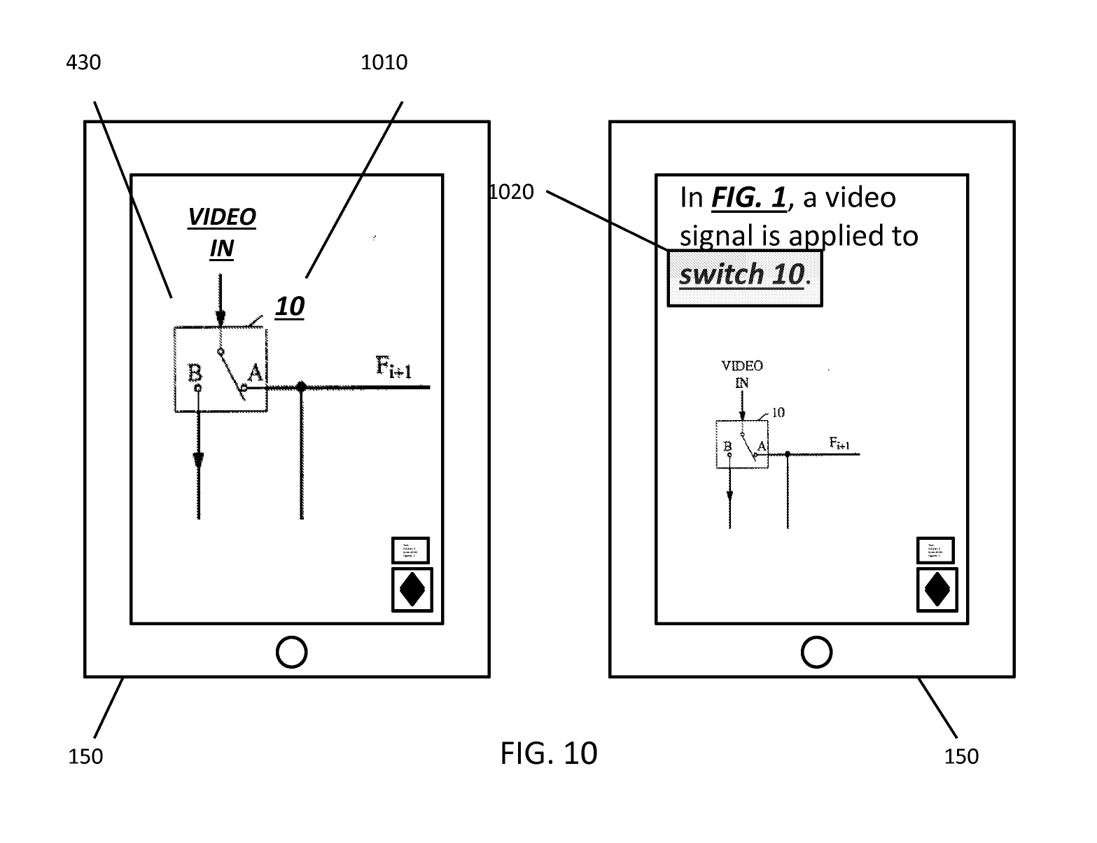

To further assist in the identification of structures within figures, and the text pertaining to those structures, FIGS. 9 and 10 depict another aspect of a user interface as follows. When reading the text of a patent document, it is often desirable to be able to locate the enumerated structures being discussed in the drawings. Accordingly, in FIG. 9, in tablet 150 on the left-hand side of the drawing, rendered text 420 includes active link text 910 whenever reference to a figure or an enumerated structure within a figure is mentioned. Touching any instance of active link text 910 automatically causes that particular figure or enumerated structure to become highlighted. This is shown in tablet 150 on the right-hand side of the drawing where highlighted structure 920, in this example “Switch 10,” has been highlighted due to the activation of the active link text 910 related to it.

Alternatively, the user could be presented with a full page text-only view of the patent specification with active-linked text, where clicking on a link would cause the bottom or top half of the page of text to be replaced by the appropriate figure with the pertinent portion of the figure (e.g., switch 10) being highlighted.

In either of these embodiments, “touching” the link (for example, by a mouse click) is but one of many ways to trigger the highlighting of the appropriate part of the relevant figure. Other methodologies have been described elsewhere in this document, and still others (e.g., known to the skilled reader) are contemplated herein.

When a particular enumerated structure is selected by the mechanism depicted in FIG. 9 and shown as highlighted structure 920, the reviewer can then use the various controls previously described with respect to it. For example, if a particular enumerated structure is included within multiple figures, a reviewer will be able to use the forward/back control 530 to move among the various instances of highlighted structure 920. The reviewer also can magnify, highlight, or annotate highlighted structure 920 using controls 610, 710, and 810.

When reviewing patent documents it is also desirable to be able to perform the reverse of the process described in FIG. 9, namely starting with the figure and identifying text related to it. Thus, conversely to FIG. 9, in FIG. 10 a reviewer begins with tablet 150 on the left-hand side of the drawing, considering integrated image 430. The enumeration of elements in integrated image 430 is once again presented as active links, such as active link structure number 1010. Touching active link structure number 1010 on tablet 150 will automatically cause the application to display the first portion of text referencing that particular structure. This is depicted on the right-hand side of FIG. 10, where “Switch 10” has been highlighted as highlighted text reference 1020. If there are multiple references to the enumerated structure selected by the reviewer, the reviewer can move among them sequentially using the same forward/back control 530 described earlier. The reviewer can also use controls 610, 710, and 810 to modify or annotate the identified text.

Once again, although “highlighting” in FIGS. 9 and 10 is shown by way of drawing a box around the particular structure in question, it should be appreciated that in operation, it may alternatively involve the use of color markings or other visual cues to draw attention to the structure. Moreover, while active link text 910 and active link structure number 1010 are described as being activated in this particular example by touching because the end device is tablet 150, it should be noted that different end devices utilizing the application will have alternative, equivalent ways of activating these active links depending on their method(s) of data input, some of which have been noted earlier.

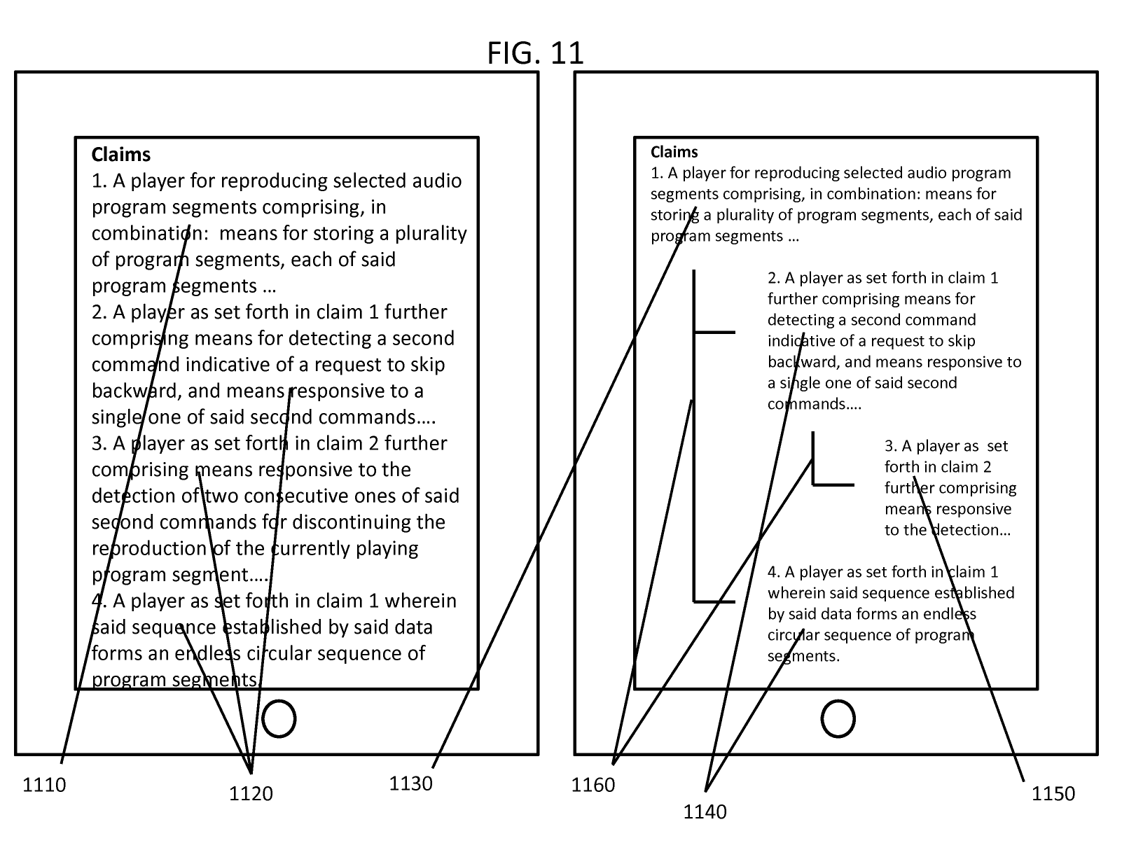

As one familiar with patent documents will understand, patent claims may be written in either independent or dependent format, with dependent claims expressly referencing whichever prior claim they are dependent upon. When reviewing a patent document, one common line of inquiry is how the various claims are written, which claims depend on other claims, and so forth. FIG. 11 shows an aspect of the user interface designed to address such questions in the form of a claim tree. In the left-hand depiction of a tablet running the application, text of the various claims are presented as rendered text in the numerical order and position one would normally find them, i.e., rendered independent claim 1110 followed directly by three rendered dependent claims 1120. When the claim hierarchy feature of the user interface is engaged, however, the result is as shown in the right-hand depiction of FIG. 11. Specifically, hierarchized independent claim 1130 is shown at a main level of indentation, while hierarchized dependent claims 1140 are shown at a secondary level of indentation. Hierarchized secondary dependent claim 1150, which is dependent upon the first of hierarchized dependent claims 1140, is shown on a tertiary level indentation. Branch lines 1160 further visually depict the dependency relationship. The user interface can redact portions of the claims to show only new elements for each additional limitation. Additionally, the user interface can build a table showing common claim elements across multiple claims.

In another embodiment, a claim dependency list can be inserted before all of the claims or before any individual claim, showing the claim dependencies and allowing the reader to hyperlink quickly into any claim. For example, if claim 2 is dependent on claim 1, and claim 4 is dependent on claim 2, then the grid could contain as its first element, the multi-link phrase 1/2/4. When the user clicks on the 1, claim 1 appears; when the user clicks on claim 2, claim 2 appears; and when the user clicks on 4, claim 4 appears. Other elements of the grid could contain all the other claim dependencies, such as 1/3, 5, 6/7/8, and so on.

Another important review task with respect to patent claims is finding every instance in the patent document where a word in the claim appears. For example, if a claim contains the word “processor,” then a patent reader frequently wants to see how that word was used elsewhere in the specification, because that usage may have an impact on claim interpretation or claim scope. However, navigating to instances of desired words and phrases from the claims can be difficult and awkward. For example, with a traditional paper patent document, one can re-read the specification multiple times looking for selected claim terms and phrases, but such a repetitive review is highly inefficient. Some electronic versions of patent documents are word-searchable, but in those instances, a reviewer is still only capable of viewing either the word search results or the claim language at any given time, but not both, and not more than one instance at a time.

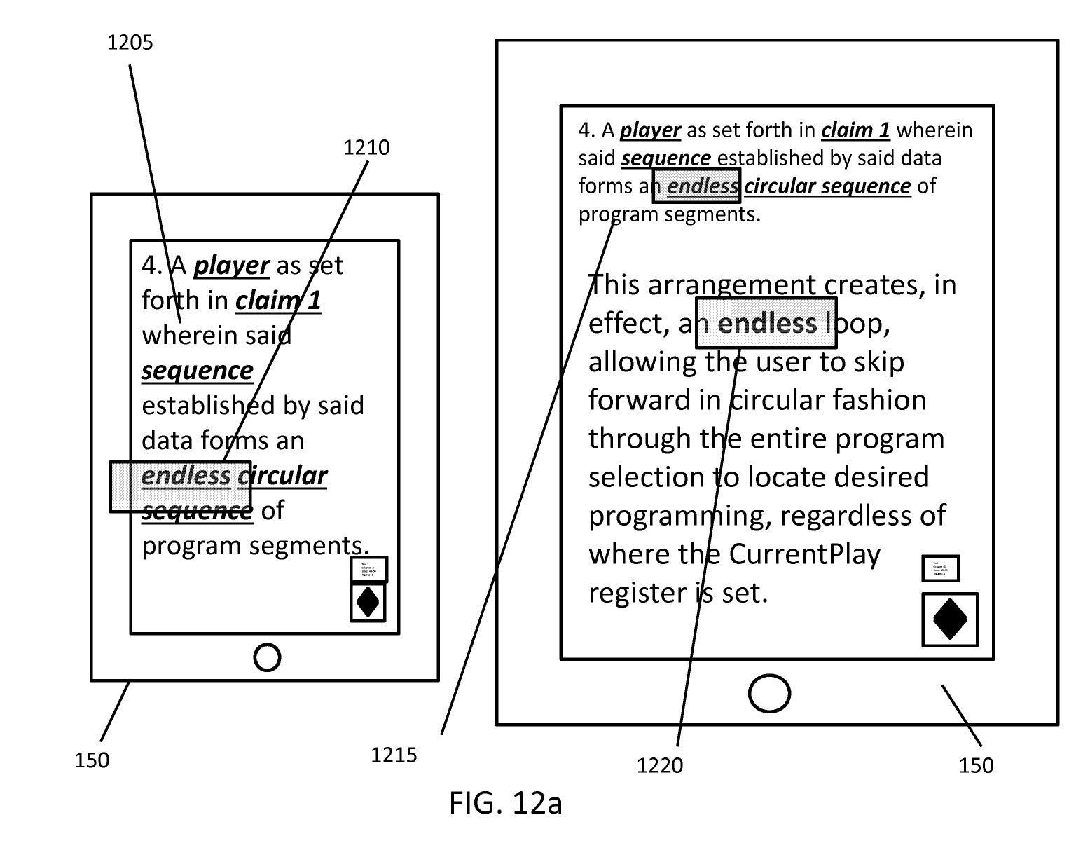

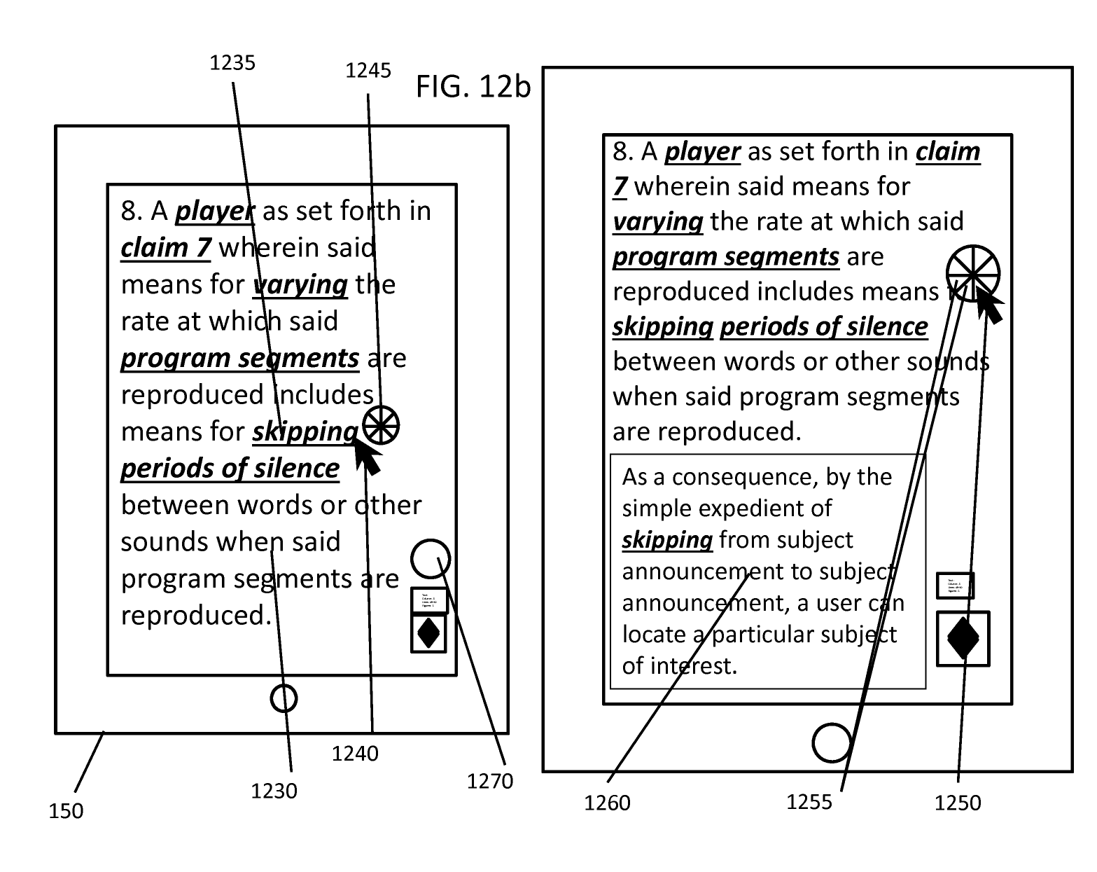

FIG. 12a depicts claim-based navigation of an interactive patent document. As shown on the left-hand side of FIG. 12a, claim language from a patent document is displayed as rendered claim text 1205, in this instance dependent claim 4. As with other portions of the user interface, key words and phrases within rendered claim text 1205 are presented as active link claim text 1210, for example “player,” “Claim 1,” “sequence,” “endless,” and “circular sequence.” Activation of any instance of active link claim text 1210 causes the user interface to present the user simultaneously with both the language of the claim in question and the first instance of the selected term, where the term is highlighted for easy reference. In this way, the reviewer can compare the entire claim and the usage of the particular term or phrase elsewhere in the document to see how the claim term is used in context. Continuing with the example depicted in FIG. 12a, when a user selects the term “endless” from the claim language presented on the left-hand iteration of tablet 150, the user is then presented with the right-hand iteration of tablet 150, in which concurrently displayed claim text 1215 is juxtaposed with a use of the word “endless” in highlighted specification text 1220. As with other aspects of the user interface described herein, if the claim term or phrase is used multiple times within the document, the user can move among them sequentially using the same forward/back control 530 described earlier. The reviewer can also use controls 610, 710, and 810 to modify or annotate the identified passages and/or figures where the term is used in context. Further, a user can shorten or lengthen a claim term it wishes to find in the specification, or employ the context-exploding techniques described earlier.

The user interface can also simultaneously display multiple portions of the specification that contain the claim term. There are many alternative ways this can be done. For example, the multiple portions can be sequenced one after the other on the lower half of the page, like paragraphs of an ordinary document. Or they can be placed as small windows in an x-y grid on the lower half of the page, so that mousing over any particular window would cause the particular portion to enlarge to more visible form.

Another approach is to have the first instance appear on the lower half of the page, but allow other, later instances to replace that instance when the user scrolls a wheel on their mouse.

Another approach causes a selector “pie” to pop onto the screen whenever the mouse cursor (or finger if using a tablet) is hovered over a linked claim term. An example of this approach appears in FIG. 12b. On the left-hand side of the drawing, rendered claim language 1230 is displayed on tablet 150. Included among active link claim text 1235, is the term “skipping.” The term “skipping” appears eight times in the text of the specification. Placing mouse cursor 1240 over “skipping” causes an eight-segmented “pie” icon 1245 to appear adjacent the word “skipping.” Moving to the right-hand side of FIG. 12b, the user can then place cursor 1250 on any of the “pie pieces” 1255. Piece 1, if selected, displays the first instance of descriptive text 1260 under the claim on the lower half of the page, so the user can see how “skipping” is used in that segment of the specification. Piece 2, if selected, displays the second instance, and so on. The pie allows the user to quickly navigate the patent text that references the word “skipping.”

By pressing CTRL and clicking on multiple pie pieces the user can cause multiple instances, for example instances 1, 3, and 7, to appear below the claim term of interest. This quick method of juxtaposing segments of the patent specification allows the user to spot inconsistencies and other useful information.

The user interface can be setup either to default to a particular method of displaying the text instances or instead can smartly choose the best method from among competing methods based on the number of separate text instances. For example, where there are one or two instances, the user interface could default to displaying sequenced text on the lower half of the page; three to six instances might display an array of windows, and seven or more instances might invoke the “pie” approach (or a chessboard/numbered array similar to the “pie” approach). Some users might find this smart selectivity to be faster than other types of navigation.

One way to measure whether a term is meaningful is a term's uniqueness. And, in some instances, a user may wish to see only those claim terms that are unique to the patent or the field of art. For example, the first time a user is reading a patent, the user may wish to see only the most unique claims. Later, when a user is preparing for a more detailed analysis, the user may wish to analyze all of the terms in the claim. Control 1270 allows the user to adjust the uniqueness of the terms identified.

To identify the uniqueness of a particular term, a term can be compared to a single patent or corpus of patents. For example, application 300 or server architecture 200 may use term frequency-inverse document frequency (TF-IDF), to rate the uniqueness of a particular term as compared to how many times that term appears in a patent or a corpus of patents. The uniqueness can also be determined by comparing the frequency of a term found in the claims using that patents specification as the corpus. The uniqueness can also be determined by using all patents with the same main classification as the corpus. The uniqueness can also be determined by using all the patents with the same main classification or further classification as the corpus. The classification could be the United States classification, international classification or other established classification.

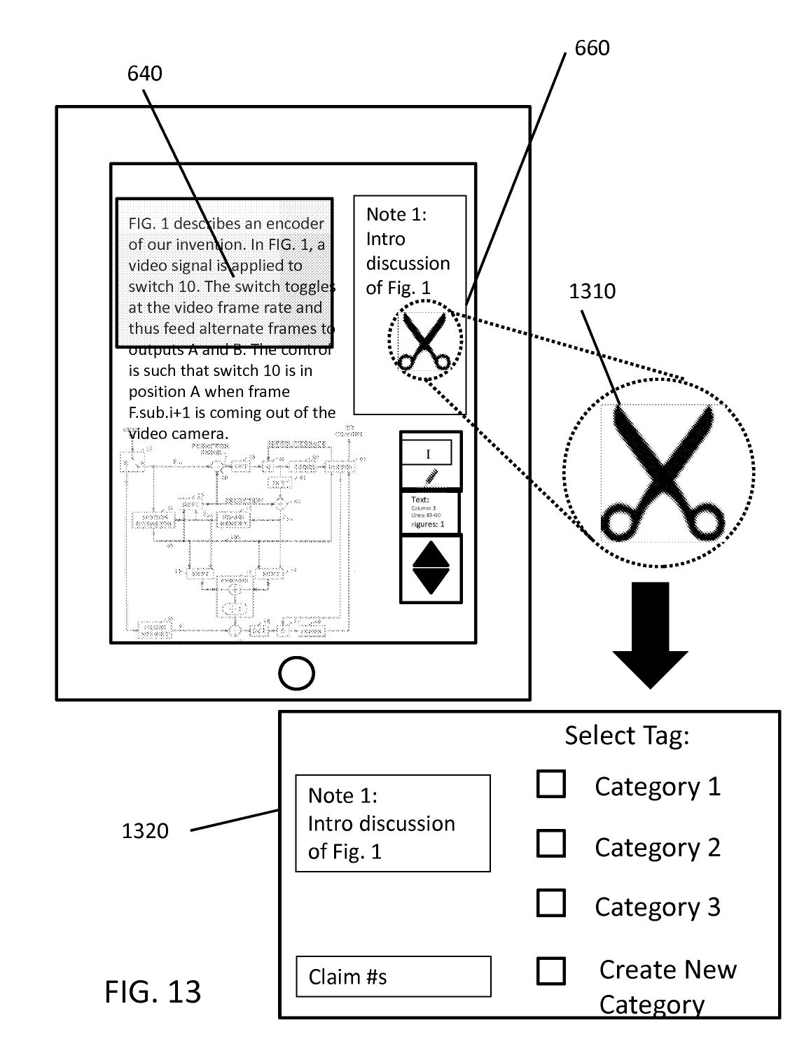

Once a review of patent documents has identified particular passages or items of interest in a particular patent document, the need may arise to compare those passages and items, to gather them for inclusion in a report or brief of some kind, or merely to tie them together with respect to particular common issues. FIG. 13 describes an aspect of the user interface that allows for such an organized aggregation. Specifically, when a reviewer creates a user text highlight 640 or a user annotation 660, the user interface presents the reviewer with a snippet creation tool 1310. Activation of snippet creation tool 1310 then presents the reviewer with the ability to tag the present annotation as pertaining to a particular issue(s) or claim(s). In FIG. 13, this ability is depicted as snippet dialogue box 1320, in which the reviewer can select among predefined tagging categories or create a new one. Once the reviewer tags user text highlight 640 or user annotation 660 as pertaining to a particular category using snippet creation tool 1310, that snippet will retain that tag or tags. Later, one can use each of the tags to retrieve the snippets identified as pertaining to that tag. As discussed below, such collections of aggregated, tagged snippets may be passed to the print engine for printing, or otherwise replicated or distributed.

While the various controls 510, 610, 710, 810, and 1310 depicted in FIGS. 5-8 and 13 have been drawn as icons, it should be appreciated that their functionality can also or alternatively be provided by way of user gestures, keystroke combinations on a keyboard, mouse clicks, or other user input devices/interactive mechanisms. As one example, reviewers using the present user interface on a workstation such as workstation 130 of FIG. 1 may have access to a traditional computer keyboard and mouse. In such an arrangement, single and double clicks of each mouse button, movements of the mouse, or certain combinations of keystrokes may be assigned to each type of task achieved by controls 510, 610, 710, 810, and 1310. As an alternative example, if the reviewer uses a tablet device, such as tablet 150 depicted in FIG. 1, or some other end device that includes touch-screen capability, various hand and finger gestures may be assigned for those same tasks.

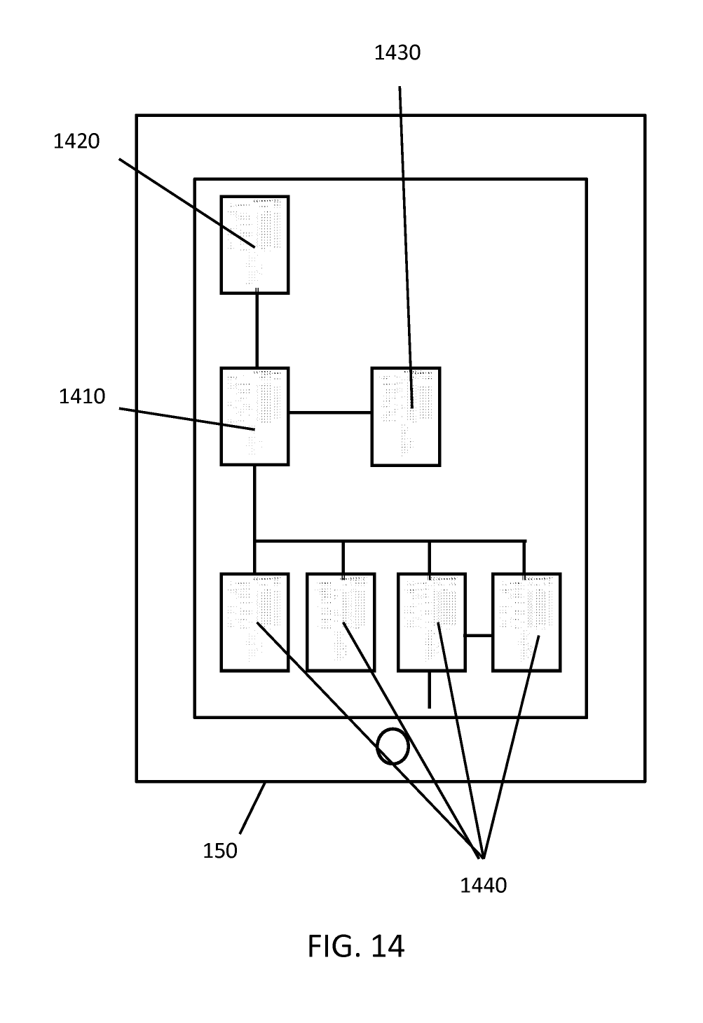

FIG. 14 depicts still another aspect of a user interface for an interactive patent document. When reviewing patent documents, it can often be helpful or important to understand what patents and applications exist that are related to the patent document in question, because related patents can shed light on issues of priority, claim scope, and so forth. In FIG. 14, original patent 1410 is the patent document with which the user began his review. Upon activation of this aspect of the user interface, however, the user interface presents the user with a chart of related patent documents in a style that resembles a family-tree. The parent of original patent 1420 is shown on a level above that of original patent 1410 in order to indicate its relatively older priority, while divisional of patent 1430 is presented on the same level. Children of original patent 1440 are displayed a level below original patent 1410. While the related patents in FIG. 14 are shown as icons, it should be understood that the presentation of related patents can take a variety of forms while still conveying the necessary information regarding their relationship to one another.

To facilitate potential review of the related patent documents, each of the additional patent documents shown in FIG. 14 includes a link, the activation of which will obtain that patent document from the database for review using the application. Similar link functionality can be provided with respect to any patent documents referenced on the cover page or within the rendered text of a patent being reviewed. The user interface can also display a timeline or dates showing the filing and issue dates of each patent.

There is a set of information pertaining to patent documents that is not typically included within the patent documents themselves. For example, while issued patents expressly indicate their filing and issue dates, they do not indicate their expiration date, although that date can be calculated consistent with the patent statutes. Similarly, while issued patents expressly indicate their initial assignee, patents are often subsequently re-assigned, with those re-assignments being recorded with the USPTO but no adjustment being made to the face of the patent. The USPTO maintains an assignment database of these re-assignments. It also maintains separate databases regarding the maintenance fees due on patents, and whether any reexaminations or reissues are associated with particular patents.

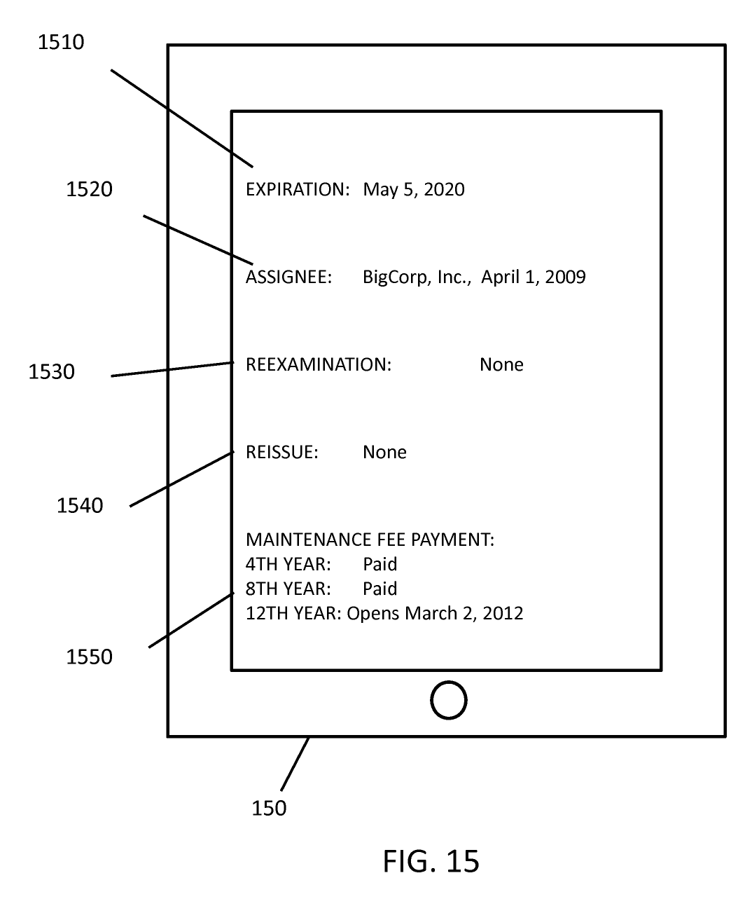

FIG. 15 depicts a yet another aspect of the user interface that addresses this additional information in an interactive patent document. With respect to expiration date 1510, the application includes an algorithm to take the issue date of a patent as expressly indicated on the patent's cover page and calculate the patent's expiration and display the result. With respect to assignment history 1520, the application contacts the server and initiates the server accessing the USPTO's assignment database. The assignment information obtained from that database is passed to the application and then displayed by the user interface. A similar process is undertaken with respect to reexamination data 1530, reissue data 1540, and maintenance data 1550, albeit with contact being initiated with the relevant database for that type of information.

Various features and options discussed above in relation to the application and user interface can be turned on or off with an options menu, or based on a particular user's past behavior. For example, the setting for linking, cross-linking, figure labels, tagging or printing can be set using an options menu or based on user behavior.

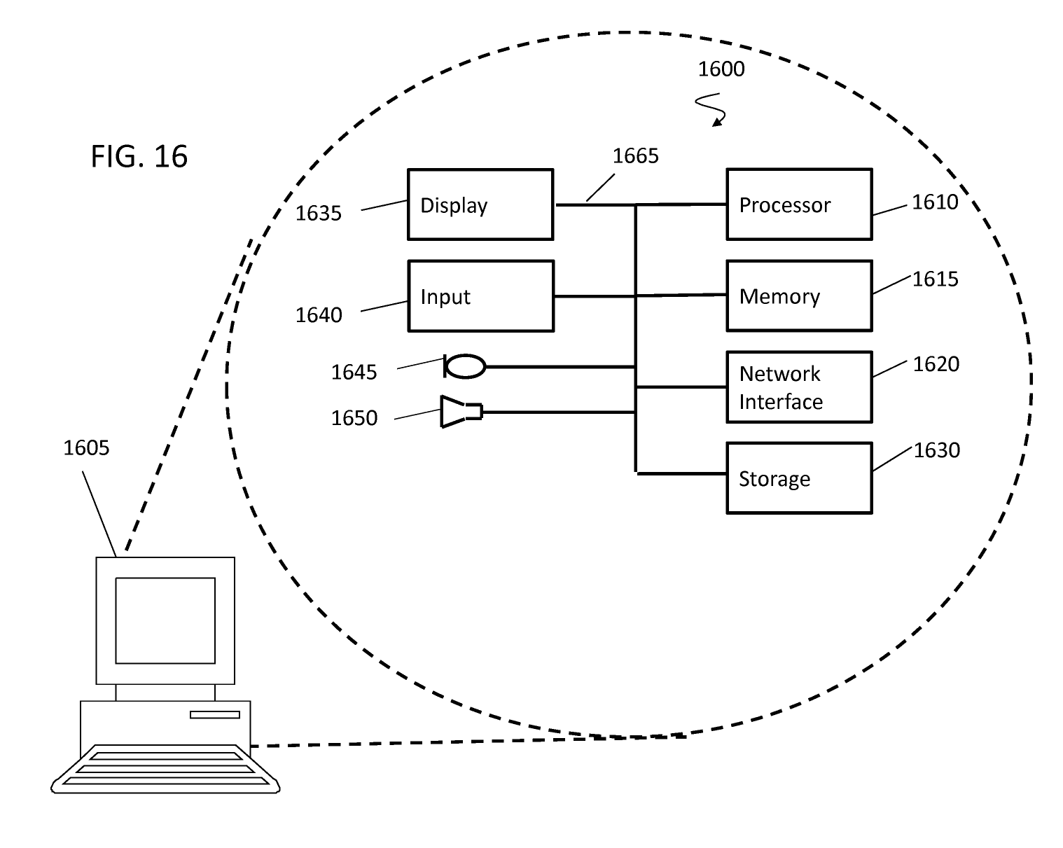

FIG. 16 shows the hardware associated with a computer workstation capable of running the user interface. FIG. 16 presents a computer system 1600 that can be used to implement the techniques described herein to create an interactive patent document. The computer system 1600 can be implemented inside of a desktop computer 1605 or another type of computer.

Computer system 1600 can include bus 1665, which can be used to transfer information between one or more additional components. Bus 1665 can include one or more physical connections and can permit unidirectional or omnidirectional communication between two or more of the components in the computer system 1600. Alternatively, components connected to bus 1665 can be connected to computer system 1600 through wireless technologies such as Bluetooth, WiFi, or cellular technology. The computer system 1600 can include a microphone 1645 for receiving sound and converting it to a digital audio signal. The microphone 1645 can be coupled to bus 1665, which can transfer the audio signal to one or more other components.

An input 1640 including one or more input devices also can be configured to receive instructions and information. For example, in some implementations input 1640 can include a number of buttons. In some other implementations input 1640 can include one or more of a mouse, a keyboard, a touch pad, a touch screen, a joystick, a cable interface, and any other such input devices known in the art. Further, audio and image signals also can be received by the computer system 1600 through the input 1640.

Further, computer system 1600 can include network interface 1620. Network interface 1620 can be wired or wireless. A wireless network interface 1620 can include one or more radios for making one or more simultaneous communication connections (e.g., WiFi, wireless, Bluetooth, cellular systems, PCS systems, or satellite communications). A wired network interface 1620 can be implemented using an Ethernet adapter or other wired infrastructure. Network interface 1620 can be used to access patent information, including patent information from the USPTO.

An audio signal, image signal, user input, metadata, other input or any portion or combination thereof, can be processed in the computer system 1600 using the processor 1610. Processor 1610 can be used to perform analysis, processing, editing, playback functions, or to combine various signals, including adding OCR'd patent images, inserting images adjacent to its corresponding text, processing text, or creating links. For example, processor 1610 also can perform calculations to cross link specification terms with figure numbers or build a claim tree. Processor 1610 can use memory 1615 to aid in the processing of various signals, e.g., by storing intermediate results. Memory 1615 can be volatile or non-volatile memory. Either or both of original and processed signals can be stored in memory 1615 for processing or stored in storage 1630 for persistent storage. Further, storage 1630 can be integrated or removable storage such as Secure Digital, Secure Digital High Capacity, Memory Stick, USB memory, compact flash, xD Picture Card, or a hard drive. Storage 1630 can be used to store a database with unprocessed patent information and/or an interactive patent file.

Information accessible in computer system 1600 can be presented on a display device 1635, which can be an LCD display, printer, projector, plasma display, or other display device. Display 1635 also can display one or more user interfaces such as an input interface. The audio signals available in computer system 1600 also can be presented through output 1650. Output device 1650 can be a speaker or a digital or analog connection for distributing audio, such as a headphone jack. In some implementations, other types of media also can be shared or manipulated, including audio or video.

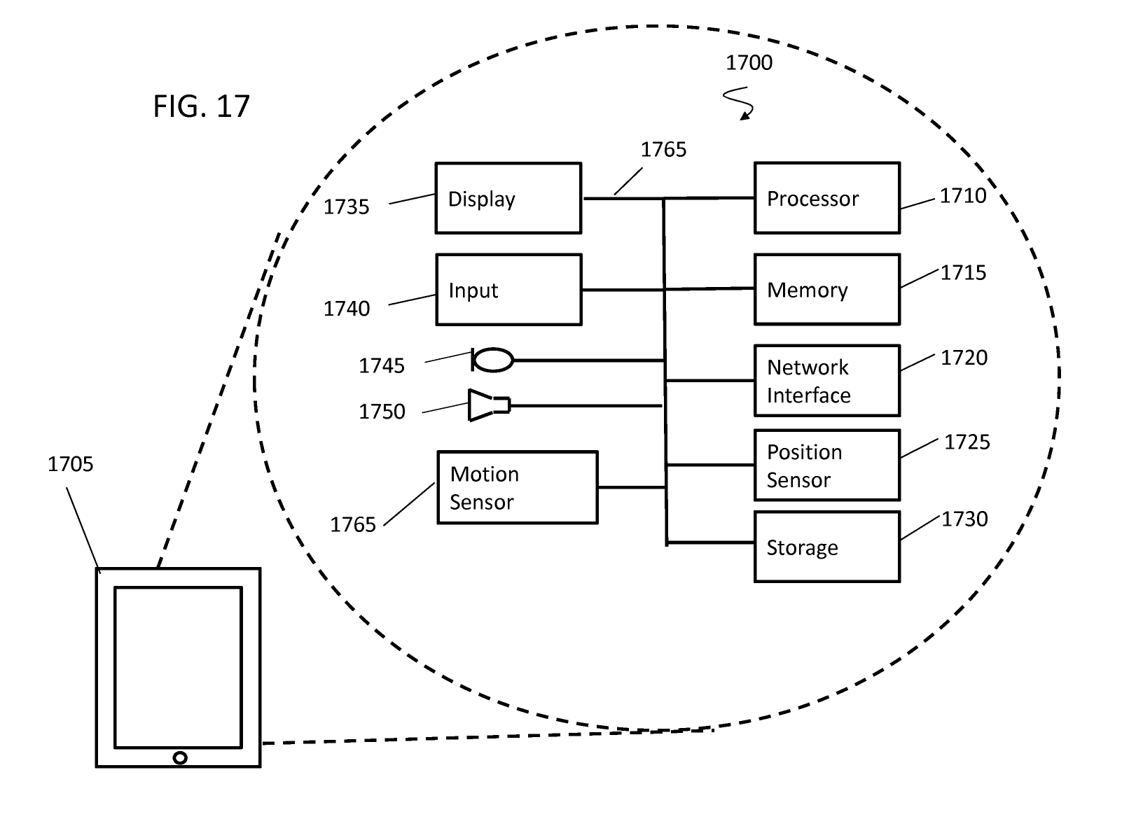

FIG. 17 shows the hardware associated with a tablet capable of running the user interface. FIG. 17 presents a computer system 1700 that can be used to implement the techniques described herein for sharing digital media. The computer system 1700 can be implemented inside of a tablet 1705 or any other computer system with the essential components. The computer system 1700 can include bus 1765, which can be used to transfer the information between one or more additional components. Bus 1765 can include one or more physical connections and can permit unidirectional or omnidirectional communication between two or more of the components in the computer system 1700. Alternatively, components connected to bus 1765 can be connected to computer system 1700 through wireless technologies such as Bluetooth, WiFi, or cellular technology. The computer system 1700 can include a microphone 1745 for receiving sound and converting it to a digital audio signal. The microphone 1745 can be coupled to bus 1765, which can transfer the audio signal to one or more other components.

The computer system 1700 can include a motion sensor 1765, e.g., by including one or more gyroscopes that detect the motion of computer system 1700. Motion sensor 1765 also can sense when the computer system 1700 has stopped moving. Motion sensor 1765 can be used to determine whether the display is in landscape or portrait mode and then size and align images and text accordingly.

An input 1740 including one or more input devices also can be configured to receive instructions and information. For example, in some implementations input 1740 can include a number of buttons. In some other implementations input 1740 can include one or more of a mouse, a keyboard, a touch pad, a touch screen, a joystick, a cable interface, and any other such input devices known in the art. Further, audio and image signals also can be received by the computer system 1700 through the input 1740.

Further, computer system 1700 can include network interface 1720. Network interface 1720 can be wired or wireless. A wireless network interface 1720 can include one or more radios for making one or more simultaneous communication connections (e.g., wireless, Bluetooth, cellular systems, PCS systems, or satellite communications). A wired network interface 1720 can be implemented using an Ethernet adapter or other wired infrastructure.

An audio signal, image signal, user input, metadata, other input or any portion or combination thereof, can be processed in the computer system 1700 using the processor 1710. Processor 1710 can be used to perform analysis, processing, or to combine various signals, including adding metadata to either or both of audio and image signals. For example, processor 1710 also can also run the render engine or print engine. Processor 1710 can use memory 1715 to aid in the processing of various signals, e.g., by storing intermediate results. Memory 1715 can be volatile or non-volatile memory. Either or both of original and processed signals can be stored in memory 1715 for processing or stored in storage 1730 for persistent storage. Further, storage 1730 can be integrated or removable storage such as Secure Digital, Secure Digital High Capacity, Memory Stick, USB memory, compact flash, xD Picture Card, or a hard drive.

The signals accessible in computer system 1700, including the interactive patent document file, can be presented on a display device 1735, which can be an LCD display, printer, projector, plasma display, or other display device. Display 1735 also can display one or more user interfaces such as an input interface. The audio signals available in computer system 1700 also can be presented through output 1750. Output device 1750 can be a speaker or a digital or analog connection for distributing audio, such as a headphone jack. In some implementations, other types of media also can be shared or manipulated, including audio or video.

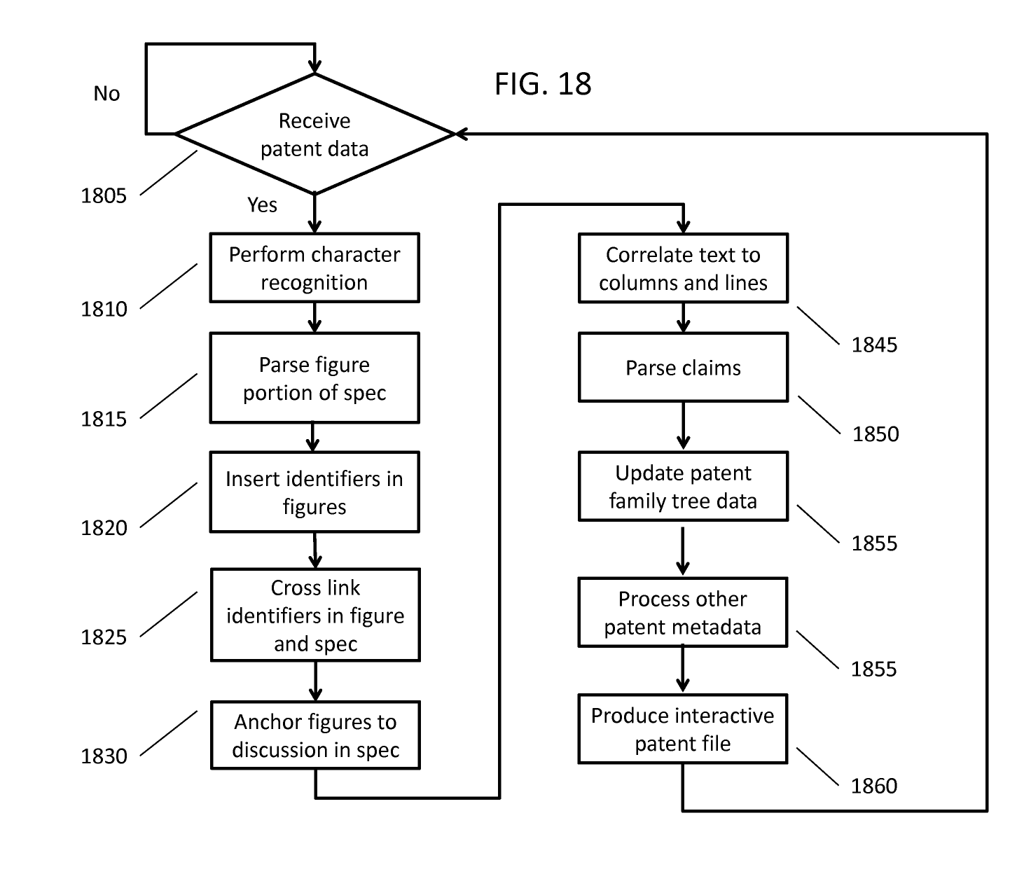

FIG. 18 shows a flowchart of the operation of the server architecture. FIG. 18 shows steps for transforming static patent information into an interactive patent document. A computer process can wait to receive patent data, including an issued patent or patent application (1805). As long as no patent data is received, the computer process can continue to monitor the connection status (905). When patent data is received, the computer process can OCR the patent data to determine if it includes any text, including OCR'ing any figures to identify their numeric labels (1810). The computer process can parse the specification, based on text data or OCR'd data (1815). Parsing the specification can include locating textual identifiers for each numeric label in the figures. Also the computer process can insert or anchor any textual identifiers into the figures (1820), either as metadata that can be shown when a user choses, or as text adjacent to the numeric label. The computer process can cross link identifiers into the specification and figures (1825) so that the numeric labels and/or identifiers jump to the portion of the specification that discusses them or selecting a numeric identifier pulls up the corresponding figure. The computer process can anchor the figures to the portion of the specification (1830) so the specification and figures can be displayed simultaneously. A single figure can be anchored multiple times. Multiple figures can be anchored together where the specification discusses them in unison.

The computer process can correlate text to column and line numbers (1845) by comparing OCR'd data of the patent data images, which include line numbers, to the raw specification text data. The column and line numbers can be stored as metadata. The computer process can also parse the claim information (1850). Parsing the claim information (1850) can include identifying dependent claims to show a tree structure. Parsing the claim information (1850) can also include using semantic and natural language techniques to identify terms that may be significant for claim-construction purposes, identifying variants of those terms, searching the specification for the term and its variants, and building a list of locations in the specification where the term is discussed for claim-based navigation. The computer process can analyze bibliographical information and access online databases to update the patents family tree data (1855), including collection and organizing metadata that shows the patents relationship to other patents. The computer process can also collect and process other metadata (1855) about the patent such as patent expiration, assignee chain, reexamination status, reissue status, and maintenance fee status. The computer process can then create an interactive patent file or a portion of an interactive patent file (1860) that can be distributed to an application capable of displaying and interacting with the file.

The steps described in FIG. 18 need not be performed in the order recited and two or more steps can be performed in parallel. In some implementations, other types of patent data can also be processed, parsed, or rendered.

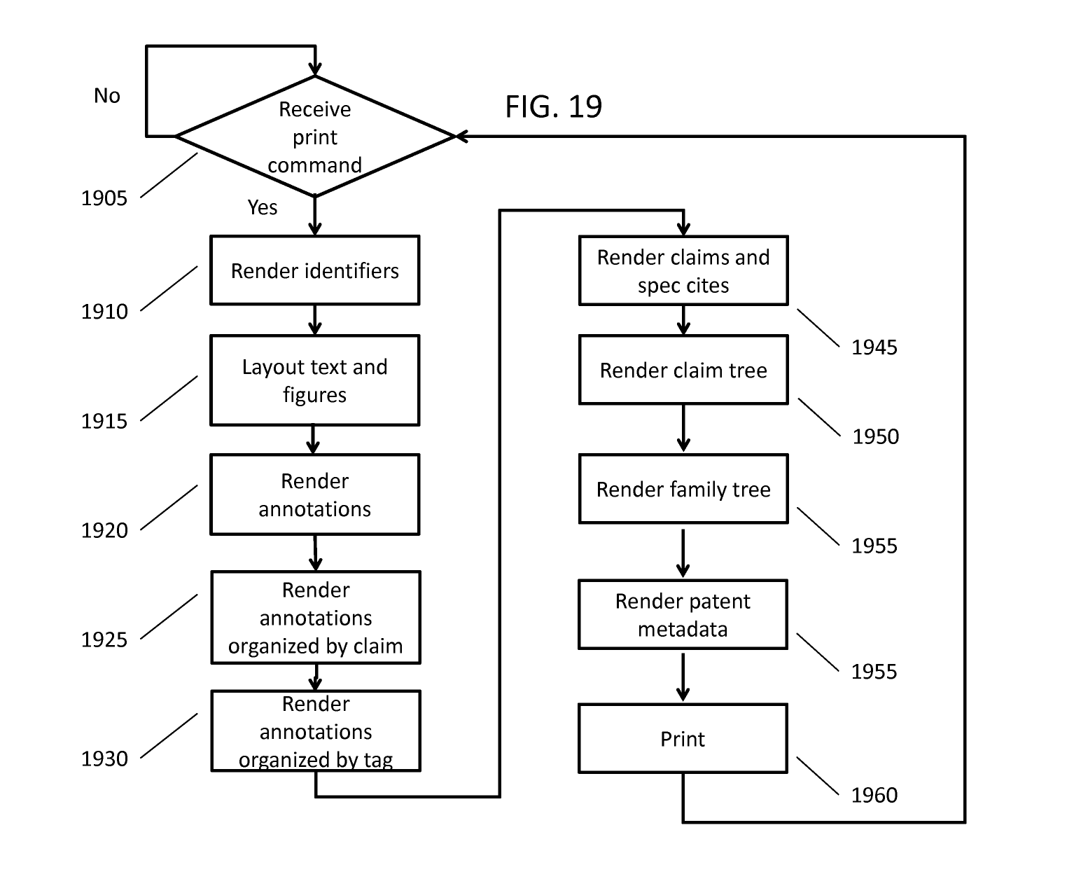

FIG. 19 shows a flowchart of the operation of the interactive patent print engine. A computer process can wait to receive a print command (1905). As long as no print command is received, the computer process can continue to monitor the connection status (1905). When a print command is received, the computer process can render figure identifiers (1910). Rendering figure identifiers (1910) can include changing the figure size based on user input and changing the location and size of identifiers based on figure size and printout size. The computer process can lay out text and FIGS. 1915) based on the figure size and printout size. The text and layout (1915) can include dynamically sizing the figure based on user input and/or the length of text discussing the figure. The computer process can also render a user's annotations (1920), including highlights, markups, comments, and tags. Rendering annotations (1920) can include putting such annotations in the margin and drawing a line between the annotation in the margin and the location of the annotation in the specification.

The computer process can render annotations organized by the claims (1925). Rendering annotations organized by claims (1925) can include inserting the claim language, followed by any annotations tagged to that claim, and/or annotations tagged to a term in that claim. Rendering annotations organized by claims (1925) can include selecting the claims and annotations to render based on user input selecting the claims. The computer process can render annotations organized by tags (1930). Rendering annotations according to tags (1930) can include inserting the tag, followed by portions of the specification tagged and any comments corresponding to a tag. Rendering annotations organized by tags (1925) can include selecting the annotations to render based on user input selecting the tags to render. The computer process can render claims and specification cites (1945). Rendering claims and specification cites (1945) can include inserting the claim language, followed by portions of the specification related to terms in that claim. Rendering annotations according to the claims (1945) can include selecting the claims and annotations to render based on user input.

The computer process can also render a claim tree (1950). Rendering a claim tree (1950) can show the dependency between claims by indenting dependent claims. Rendering a claim tree (1950) can also include showing an abbreviated form of a claim that only includes “new elements.” Rendering a claim tree (1950) can also include building a table showing common claim elements across multiple claims.

The computer process can also render a family tree (1955). Rendering a family tree (1955) can include requesting an update regarding family tree information from a network. Rendering a family tree (1955) can include drawing a tree showing the relationships between all patents in a family. Rendering a family tree (1955) can include a timeline that shows that filing and/or issue dates of all patents in the family tree. The computer process can render patent metadata (1955), including assignee information, reissue information, reexamination information, expiration date, and maintenance fee data. The computer process can print (1960) the laid out and rendered information. Printing (1960) can include producing an electronic document, such as a pdf or Word document, or transmitting data for printing on paper. Printing (1960) can include incorporating hyperlinks and crosslinks found in the interactive patent. Printing (1960) can include printing indexes, tables of contents, and other summary information. Printing (1960) can include printing portions of the interactive patent designated by the user and omitting other portions.

The document produced by the computer process can also be displayed by the application 300 in a presentation mode. The presentation mode could be used to present various pieces of the patent and analysis to other interested parties in summary form.

The steps described in FIG. 19 need not be performed in the order recited and two or more steps can be performed in parallel. In some implementations, other types of patent data can also be process, parsed, or rendered. The various diagrams illustrating various embodiments may depict an example architectural or other configuration for the various embodiments, which is done to aid in understanding the features and functionality that can be included in those embodiments. The present disclosure is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement various embodiments. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

It should be understood that the various features, aspects and/or functionality described in one or more of the individual embodiments are not limited in their applicability to the particular embodiment with which they are described, but instead can be applied, alone or in various combinations, to one or more of the other embodiments, whether or not such embodiments are described and whether or not such features, aspects and/or functionality is presented as being a part of a described embodiment. Thus, the breadth and scope of the present disclosure should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

Moreover, various embodiments described herein are described in the general context of method steps or processes, which may be implemented in one embodiment by a computer program product, embodied in, e.g., a non-transitory computer-readable memory, including computer-executable instructions, such as program code, executed by computers in networked environments. A computer-readable memory may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

As used herein, the term module/component can describe a given unit of functionality that can be performed in accordance with one or more embodiments. As used herein, a module/component might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various module/component described herein might be implemented as discrete module/component or the functions and features described can be shared in part or in total among one or more modules. In other words, as would be apparent to one of ordinary skill in the art after reading this description, the various features and functionality described herein may be implemented in any given application and can be implemented in one or more separate or shared module/component in various combinations and permutations. Even though various features or elements of functionality may be individually described or claimed as separate module/component, one of ordinary skill in the art will understand that these features and functionality can be shared among one or more common software and hardware elements, and such description shall not require or imply that separate hardware or software components are used to implement such features or functionality. Where components or modules of the invention are implemented in whole or in part using software, in one embodiment, these software elements can be implemented to operate with a computing or processing module/component capable of carrying out the functionality described with respect thereto. The presence of broadening words and phrases such as “one or more,” “at least,” “but not limited to” or other like phrases in some instances shall not be read to mean that the narrower case is intended or required in instances where such broadening phrases may be absent.

What is claimed is:

1. An apparatus, comprising:
a parser for parsing textual components of a patent document; and
an interactive patent document creator operatively connected to the parser for creating an interactive document based upon the parsed patent document.

2. The apparatus of claim 1 further comprising, a local database for storing at least one of the patent document, additional documents related to the patent document, and information relevant to the patent document.

3. The apparatus of claim 2, wherein the local database is operatively connected to at least one remote patent database from which the patent document, the additional documents related to the patent document, and the information relevant to the patent document is received.

4. The apparatus of claim 1 further comprising, an image processor for performing optical character recognition to identify the textual components, wherein the textual components are included within at least one figure of the patent document.

5. The apparatus of claim 4, wherein the image processor further performs at least one of the following:
extracting at least one figure from the patent document;
cropping the at least one figure;
rotating the at least one figure;
enhancing the at least one figure;
linking textual labels associated with the at least one figure to at least one portion of the textual specification within the interactive document; and
overlaying textual identifiers within the at least one portion of the textual specification adjacent to the textual labels within the at least one figure.

6. The apparatus of claim 1 further comprising, a language engine operatively connected to and utilized by the parser for performing the parsing of the textual components, the language engine performing at least one of the following:
identifying meaningful claim terms within the textual components;
identifying of a beginning and ending of the meaningful claim terms;
determining whether the meaningful claim terms have antecedent basis; and
determining variants of the meaningful claim terms.

7. The apparatus of claim 1, wherein the parser further performs at least one of the following:
locating textual identifiers for at least one textual label in at least one figure of the patent document;
identifying and inserting at least one link between the at least one figure and a specification portion of the patent document;
anchoring the at least one figure to at least one aspect of the specification portion of the patent document;
correlating at least one of the textual components to identifying markers;
building of family tree data associated with the patent document; and
collecting and processing metadata associated with the patent document.

8. The apparatus of claim 7, wherein the metadata comprises at least one of an expiration date; an assignee chain; a reexamination status, a reissue status, and maintenance fee status.

9. The apparatus of claim 1, wherein the parser further performs at least one of the following:
identifying dependency of claims within the textual components;
identifying of commonality of claim terms utilized within the claims;
locating, in a specification portion of the patent document, the claim terms;
analyzing antecedent basis of the claim terms;
identifying derivation of the antecedent basis of the claim; and
marking antecedent relationships reflected in the analysis of antecedent basis of the claim terms.

10. An apparatus, comprising:
a processor; and
a memory including computer program code, the memory and the computer program code configured to, with the processor, cause the apparatus to perform at least the following:
identifying at least one of letters and numbers in patent data associated with an original patent document;
extracting at least one figure from the patent data; and
creating an interactive patent document allowing for interaction with the patent data based on the at least one of the letters and numbers, and the at least one figure.

11. The apparatus of claim 10, wherein the identification of the at least one of the letters and numbers is performed using optical character recognition.

12. The apparatus of claim 10, wherein the memory and the computer program code configured to, with the processor, cause the apparatus to further perform at least one of cropping, rotating, and enhancing of the at least one figure within the interactive patent document.

13. The apparatus of claim 10, wherein the memory and the computer program code configured to, with the processor, cause the apparatus to further perform the insertion of links between numeric labels of the least one figure and a specification portion of the original patent document, the numeric labels comprising at least a portion of the identified letters and numbers.

14. The apparatus of claim 13, wherein the links are provided by at least one of a parsing module and language engine.

15. The apparatus of claim 10, wherein the memory and the computer program code configured to, with the processor, cause the apparatus to further perform overlaying of text identifiers found in a specification portion of the original patent document adjacent to numeric labels of the least one figure, the numeric labels comprising at least a portion of the identified letters and numbers.

16. A method, comprising:
receiving patent data associated with a patent document;
performing character recognition to parse at least one figure portion of the patent document;
inserting textual identifiers into the at least one figure, the textual identifiers being determined for each numeric label of the at least one figure via the parsing;
cross-linking the textual identifiers between the at least one figure and a specification portion of the patent document;
anchoring the at least one figure to at least one aspect of the specification portion; and
producing an interactive patent file incorporating the textual identifiers and the at least one figure, the interactive patent file providing interactive capabilities based upon the inserted and cross-linked textual identifiers, and the at least one anchored figure.

17. The method of claim 16 further comprising, correlating text of the specification portion to identifying markers within the specification portion.

18. The method of claim 16 further comprising, parsing claim data of the patent document.

19. The method of claim 16 further comprising, updating family tree data associated with the patent document.

20. The method of claim 16 further comprising, processing additional patent metadata associated with the patent document.
